(19) United States
(12) Patent Application Publication
(10) Pub. No.: US 2008/0041467 A1
(43) Pub. Date: Feb. 21, 2008

(54) Digital control valve assembly for a hydraulic actuator

(75) Inventor: Dale A. Stretch, Novi, MI (US)

Correspondence Address: Donald J. Harrington;Brooks Kushman P.C., 22nd Floor, 1000 Town Center, Southfield, MI, 48075-1238, US

(73) Assignee: Eaton Corporation, Cleveland, OH (US)

(21) Appl. No.: 11/505,706

(22) Filed: Aug. 16, 2006

(51) Int. Cl. F15B 13/044

(52) U.S. Cl. 137/596.17; 251/129.1

(57) ABSTRACT

A digital valve assembly controls a reciprocating valve element. The valve assembly has two actuator valve spools that are activated selectively by three solenoids to either of two operating positions for each valve spool. Fluid flow metering areas for the valve spools are calibrated for desired reciprocating valve timing, lift rates and closing rates.

### BACKGROUND OF THE INVENTION

1. Field of the Invention

The invention relates to dual digital valves for controlling hydraulic actuators.

2. Background Discussion

A camless internal combustion engine typically includes hydraulic valve lifters for a pair of engine valves for each engine cylinder. The valve lifters, herein called engine valve actuators, are controlled by two actuator valve assemblies, each actuator valve assembly having a pair of two-position valve spools under the control of a pair of solenoid actuators. Control pressure is distributed to each of the actuator valve assemblies by a switching valve, which also has a two-position valve spool controlled by one or more solenoid actuators. The solenoid actuators for the switching valve and the two actuator valve assemblies are controlled by an engine controller so that the timing of the movement of the valve spools from one position to the other is a function of engine crank position. Engine crank position and engine valve lift have a precalibrated relationship defined by control software stored in memory registers of the engine controller. Each engine valve is selectively opened and closed as one of the actuator valve spools selectively connects an engine valve actuator to a control pressure or to a zero pressure reservoir. The actuator valve spools for each engine valve actuator are switched between their two positions by alternately energizing and de-energizing the solenoid actuators.

The requirement for a pair of solenoid actuators for each hydraulic actuator valve spool results in a relatively complex control valve system with a manufacturing cost penalty and a space penalty.

A conventional hydraulic engine valve control system requires the use of a single-acting, two-stage hydraulic actuator for each engine valve. In this way, the characteristic relationship of engine valve lift and engine crank angle can be modified to provide a pre-calibrated fast engine valve lift rate and a fast engine valve closing rate followed by a slower engine valve closing rate as each engine valve engages its valve seat. This requirement for a two-stage engine valve actuator further increases the complexity and cost of the overall design.

Another example of a known hydraulic actuator system for internal combustion engine valves is described in UK Patent Application Publication GB 2373824, dated Oct. 2, 2002. That actuating system has a two-position switching valve operated by a single solenoid, the force of the solenoid being opposed by a spring force. Two valve spools, each of which has two operating positions, separately control two engine valves by selectively distributing valve actuating pressure to open the engine valves against an opposing spring force. As in the case of the present invention, the system described in the UK patent application has an engine valve position transducer that generates an electrical voltage signal indicative of the position of the engine valve. That signal is delivered to an electronic engine controller in a closed-loop feedback control arrangement. A switching valve, which is a three-port, two-way digital valve, is used to distribute control pressure to each of the two valve spools. One valve spool controls the motion of one engine valve and the other valve spool controls the motion of the other engine valve. As in the case of the switching valve, the valve spools are actuated by a single solenoid, which produces an electromagnetic force that is opposed by a spring force.

The hydraulic actuators for the engine valves disclosed in the UK publication are single-acting, single-stage actuators.

### SUMMARY OF THE INVENTION

It is an objective of the present invention to provide a simplified actuator design for a reciprocating valve, such as an engine valve, by reducing the number of solenoid actuators and to simplify an electrical circuit for the solenoid actuators. This is accomplished by providing a digital valve assembly with only three solenoid actuators for two hydraulic valve spools, whereby the hydraulic valve spools share one of the three solenoid actuators. Each of the hydraulic valve spools may be calibrated so that they establish a desired flow rate for a given pressure differential across the valve spools. The relationship between engine valve lift and engine crank position then can be tailored to provide a desired engine valve lift rate during opening of the engine valve, and a reduced engine valve closing rate as the engine valve approaches its valve seat. In this way, engine valve wear and engine valve deceleration forces during engine valve closure are reduced. In accordance with one aspect of the invention, this is achieved without the necessity for using a two-stage hydraulic engine valve actuator.

Unlike a hydraulic actuator valve assembly of known design, which has two solenoid actuators for each of two actuator valve spools, the design of the present invention has two valve spools for each of the engine valve actuators and a common solenoid actuator that shifts each of the actuator valve spools to one of its positions. Each actuator valve spool is shifted to its other position by a separate solenoid actuator.

One of the embodiments of the present invention includes a single-acting, single-stage engine valve actuator and a two-way digital switching valve, the switching valve serving two solenoid-operated actuator valve assemblies. A second embodiment of the invention includes a single-acting, two-stage engine valve actuator and two solenoid-operated actuator valve assemblies. As in the case of the first embodiment, each engine valve actuator of the second embodiment has two solenoid-operated actuator valve assemblies, but the second embodiment does not require a switching valve. In each embodiment, however, each solenoid-operated actuator valve assembly uses only three solenoid actuators rather than two solenoid actuators for each valve spool.

The present invention can be used to control two engine intake valves. The invention can be used also in other engine valve arrangements where one actuator controls an intake valve and the other controls an exhaust valve. The invention can be used in still other environments, such as an engine exhaust gas recirculation control valve or other gas exchange valves.

### BRIEF DESCRIPTION OF THE DRAWINGS

FIG. 1 is a schematic diagram of a known hydraulically operated engine valve system using a switching valve and two electromagnetically controlled actuator valve assemblies;

FIG. 1a is an isometric view shown in cross section of the known engine valve arrangement schematically illustrated in FIG. 1.

FIG. 1b is a cross-sectional view of a two-stage single-acting engine valve actuator of known design;

FIG. 2 is a plot showing valve lift data for the conventional design of FIG. 1 as engine crank position changes, together with a diagram showing actuator valve spool porting and switching valve porting;

FIG. 3 is a schematic diagram of one embodiment of the invention, which includes a single-acting, single-stage engine valve actuator;

FIG. 3a is a schematic cross-sectional view of the two-stage solenoid actuated actuator valve assembly of FIG. 3;

FIG. 4 is a plot of valve lift for various engine crank positions for the embodiment of the invention shown in FIG. 3;

FIG. 5 is a plot showing the flow characteristics across the solenoid-operated two-stage actuator valve assembly of FIG. 3, wherein flow is plotted for various values of a pressure differential across valve spools;

FIG. 6 is a plot illustrating the valve spool positions for the solenoid-operated actuator valve assembly and for the switching valve of the embodiment of FIG. 3 for various engine crank positions;

FIG. 7 is a schematic diagram of solenoid-operated actuator valve assemblies for a second embodiment of the invention, which include a single-acting, two-stage engine valve actuator;

FIG. 8 is a schematic cross-sectional view of the two-stage, solenoid-operated actuator valve assembly illustrated in FIG. 7;

FIG. 9 is a plot showing valve lift for various engine crank positions for the single stage solenoid actuated actuator valve assembly of FIG. 7;

FIG. 10 is a plot showing open and closed positions for the two-stage, solenoid-operated actuator valves of FIG. 7;

FIG. 11 is a cross-sectional view of a pair of solenoid-operated actuator valve spools corresponding to the valve spools of FIG. 3a, but which includes a modified valve spool stop;

FIG. 12 is a plot showing the relationship of magnetic flux intensity and residual magnetism for solenoid-operated actuator valves of the kind illustrated in FIG. 11;

FIG. 13 is a plot showing flow metering areas for a typical spool valve; and

FIG. 14 is a plot of axial force acting on the spool valve of FIG. 13 for various valve spool displacements.

### PARTICULAR DESCRIPTION OF THE INVENTION

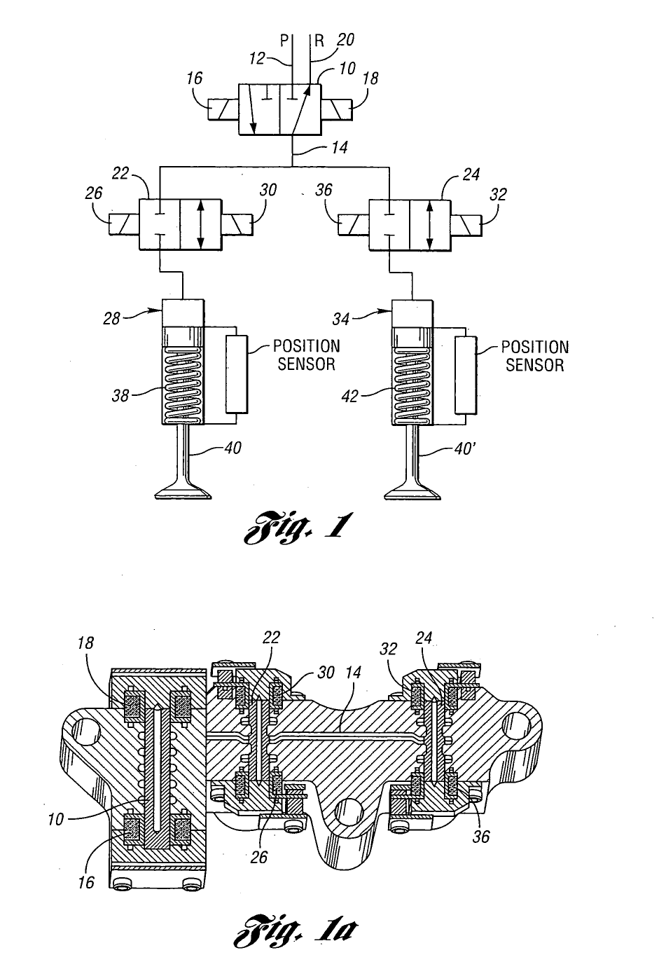

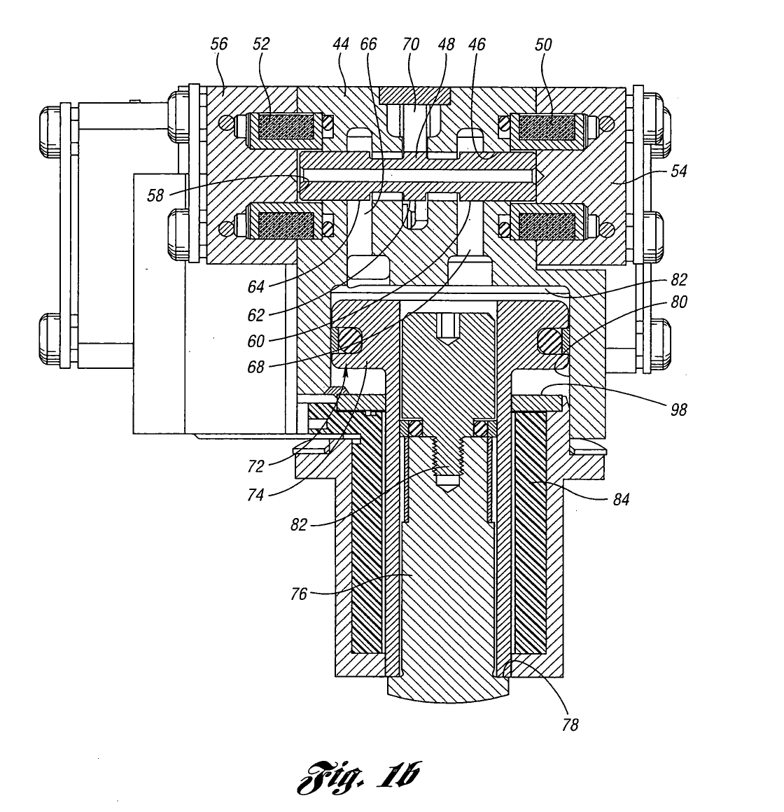

FIG. 1 shows, in schematic form, an internal combustion engine valve lifter mechanism, which is generally similar to the hydraulic valve actuating system described in UK patent application publication GB 2373824, previously described. Unlike the system shown in the publication, however, the system shown in FIG. 1 uses two solenoids for each of two solenoid-operated actuator valves assemblies, rather than a single solenoid.

A two-position switching valve is shown at 10. A pressure inlet port 12 provides a pressure distribution path to a control pressure passage 14 when a first solenoid 18 is energized. When a second solenoid 16 is energized, control pressure passage 14 is connected to a reservoir low pressure passage 20. Passage 14 communicates with each of two actuator valve spools 22 and 24. Each of these valve spools is a two-position valve spool, each valve spool being under the control of a separate pair of solenoid actuators. When solenoid actuator 30 is energized, actuator valve spool 22 blocks communication between passage 14 and an engine valve actuator schematically shown at 28. When solenoid 26 is energized, valve spool 22 is shifted so that passage 14 distributes control pressure to engine valve actuator 28. In a similar fashion, actuator valve spool 24 is shifted to an open valve porting position when its solenoid actuator 36 is energized, whereby control pressure passage 14 will communicate with a single-acting, two-stage engine valve actuator 34. When solenoid actuator 32 is energized, valve spool 24 will shift to a closed porting position whereby control pressure from passage 14 is blocked from the engine valve actuator 34.

Engine valve actuator 28 opens engine valve 40 when the actuator is pressurized. A valve spring 38 returns the engine valve 40 to its closed position when the actuator 28 is depressurized.

Engine valve actuator 34 moves engine valve 40′ to its open position when pressure is distributed to it from actuator valve spool 24. Valve spring 42 returns the engine valve 40′ to its closed position when the engine valve actuator is depressurized.

FIG. 1a is a cross-sectional view illustrating the elements that are schematically shown in FIG. 1.

FIG. 1b is a cross-sectional view that shows the structure of FIG. 1a in a more detailed form. It shows a valve body 44, which is provided with a valve opening 46. An actuator valve spool 48 is received in the valve opening 46. A first solenoid actuator 50 mounted within solenoid body 54 is situated at a first end of the actuator valve spool 48. A second solenoid actuator 52 mounted within a solenoid body 56 is located at the opposite end of actuator valve spool 48. The body 54 provides a stop that is engaged by the first end of the actuator valve spool 48. Solenoid body 56 provides a stop for the opposite end of the actuator valve spool 48. An air gap 58 is provided between the solenoid body 56 and the opposite end of the actuator valve spool 48.

Valve spool 48 has three valve lands 60, 62 and 64. Lands 64 and 60 register with pressure supply ports 66 and 68, respectively. When the valve is positioned as shown in FIG. 1b, valve land 60 provides metered control pressure distribution from control pressure supply passage 70 to the port 68. Simultaneously, land 62 provides metered control pressure distribution between port 70 and port 66. The valve spool 48 assumes the position shown in FIG. 1b when solenoid actuator 50 is energized.

When solenoid actuator 52 is energized, valve spool 48 will be shifted in a left-hand direction thereby closing the air gap 58. This will cause valve land 60 to block communication between control pressure supply port 70 and port 68. Likewise, land 62 will block communication between control pressure supply port 70 and port 66. Ports 66 and 68 are open to port 70 when solenoid actuator 50 is energized.

The engine valve actuator includes a two-stage piston 72, which comprises a large diameter piston portion 74 and a small diameter piston portion 76. Piston portion 76 is slidably received in a cylindrical opening in the piston portion 74. The lower end of the piston portion 76 has a shoulder 78, which engages the lower end of large diameter piston portion 74. A cylinder 80 receives the two-stage piston 72 and cooperates with the two-stage piston portion 72 to define a control pressure chamber 82, which communicates with ports 66 and 68. Preferably, the small diameter piston portion 76 is formed in two parts. The lower part has a threaded opening that receives a threaded end of the upper portion of the small diameter piston portion 76. This is shown at 82.

A piston position sensor is schematically shown at 84. It comprises position transducer electrical windings that surrounds the two-stage piston 72. As the two-stage piston moves in the cylinder 80, the resulting change in inductance created by the transducer windings is an indicator of piston position. The transducer windings provide a signal that is distributed to an engine controller (not shown).

The lower end of the small diameter piston portion 76 engages an engine valve, as generally indicated in the schematic system drawing of FIG. 1. The engine valve is opened against the opposing force of an engine valve spring, as previously explained, when the two-stage piston is advanced in a downward direction under the force created by hydraulic pressure in the chamber 82.

The engine controller must selectively activate the switching valve and the actuator valves of FIG. 1 at precise engine crankshaft positions. The relationship of engine crankshaft position to valve lift and to the opening and closing patterns for the actuator valve assembly of the present invention and the switching valve are illustrated in FIG. 2. At an initial crankshaft position, the switching valve porting is closed, as shown at 86 in FIG. 2. At crankshaft position 88, the switching valve is opened, as indicated at 90. This is done by energizing (firing) a solenoid of the switching valve. The opening of the switching valve is followed after a very short interval by the opening the actuator valve assembly porting, as shown at 92. The open position of the actuator valve assembly 48 is indicated at 94. At that instant, distribution of hydraulic pressure to the actuator for the engine valve begins to increase, as shown at 96. The initial valve lift is achieved as the two-stage piston 72 is moved under the force of hydraulic pressure in chamber 82 against an opposing engine valve spring force. When the large diameter piston portion 74 engages piston stop shoulder 98, seen in FIG. 1b, the small diameter piston portion 76 will continue to move. Since the small diameter piston portion displaces a smaller volume of pressurized fluid, the valve lift rate is increased. This is indicated at 100 in FIG. 2. The change in slope in the valve lift plot 96 relative to the valve lift plot 100 is defined by a break point 102.

The engine valve actuator is stroked at 104 to its predetermined position, as shown in FIG. 2. The switching valve porting will remain open, as shown at 106, but the actuator valve assembly 22 will remain closed, as shown at 108. Since valve lift will remain unchanged, as shown at 104. The switching valve is closed by a command by the engine controller, as shown at 110. This occurs an instant prior to the opening of the engine valve actuator, as shown at 112. At that instant, the solenoid actuator 52 is energized, thereby closing the air gap 58 and establishing a drain passage from the pressure chamber 82 to the actuator valve port 70. The valve lift decreases with a slope 114 that is determined by appropriately calibrating the flow metering lands for the actuator valve. Initially, the slope, indicated at 114, results from displacement of fluid by the small diameter piston portion 76 as the displacement of piston portion is opposed by the engine valve spring force. When the crank position is at an intermediate value, a break point occurs as shown at 116. At that instant, both the small diameter piston portion and the large diameter piston portion displace fluid, which results in an engine valve spring-controlled lower slope 118 in the valve lift plot shown in FIG. 2. At the end of the closing of the engine valve, the actuator valve assembly porting again is closed, as shown at 120. The lower slope at 118 relative to the slope at 114 is desirable since it will provide a softer valve landing as the engine valve head engages its valve seat, thereby reducing the rate of valve wear and valve seat wear and lowers valve impact stress and noise.

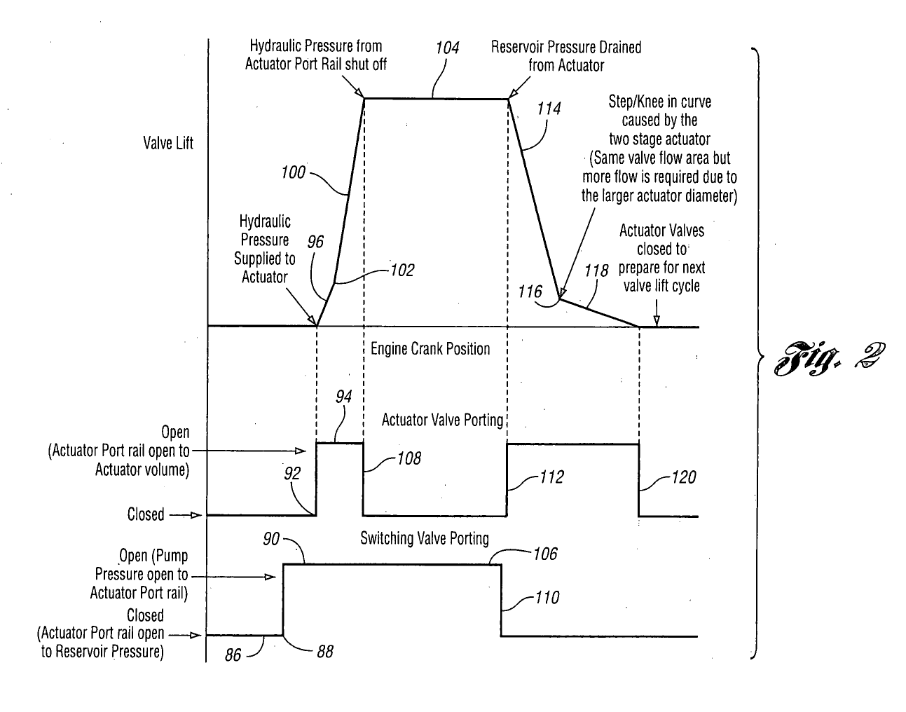

FIGS. 3-6 show a first embodiment of the invention. It should be noted that each valve spool of the valve system of FIGS. 1-2 requires two solenoid actuators. In contrast to that known valve arrangement, the first embodiment of Applicant's invention has two actuator valve assemblies wherein each actuator valve assembly has only three solenoid actuators rather than four. The first embodiment of Applicant's invention is shown in schematic form in FIG. 3. A switching valve is shown in FIG. 3 at 122. As in the case of the known valve system of FIGS. 1-2, the valve system of FIG. 3 has a switching valve with two positions, schematically illustrated at 124 and 126. The two-position switching valve 122 has two solenoid actuators shown at 128 and 130. A pressure supply passage for the pair of actuator valve assemblies is shown at 132. A pressure port is shown at 134 and an exhaust port communicating with a reservoir is shown at 136. When solenoid 128 is energized and solenoid 130 is de-energized, passage 132 communicates with port 134. When solenoid 130 is energized and solenoid 128 is de-energized, passage 132 communicates with port 134.

A first actuator valve spool is shown at 138. A second actuator valve spool is shown at 140. Solenoid actuators 142, 144 and 146 are aligned with valve spools 138 and 140 on a common axis. When solenoid actuator 142 is energized and solenoid actuator 144 is de-energized, actuator valve spool 138 is shifted to the position shown at 148, which blocks communication between actuator inlet passage 150 and pressure passage 132.

When solenoid actuator 142 is de-energized and solenoid actuator 144 is energized, the actuator valve spool 138 is shifted to the position shown at 152, which allows communication between actuator pressure passage 150 and pressure passage 132. When solenoid actuator 144 is energized and solenoid actuator 146 is de-energized, communication between passage 150 and passage 132 is established. When solenoid actuator 146 is energized and solenoid actuator 144 is de-energized, pressure passage 132 is blocked from passage 150.

Actuator valve spools 138 and 140 control pressure distribution to a single-acting, single-stage engine valve actuator 154, which comprises an actuator piston 156 mechanically connected to a reciprocating valve, such as engine valve 158. Pressure distributed to the engine valve actuator through pressure passage 150 is opposed by the force of spring 160.

Actuator valve spools 138′ and 140′ control a second engine valve actuator 154′. Actuator valve spool 140′ corresponds to the actuator valve spool 140, actuator valve spool 138′ corresponds to actuator valve spool 138 and the actuator 154′ corresponds to actuator 154. Elements of the actuator 154′ and the actuator valve spools 138′ and 140′ correspond to elements of the actuator 154 and the actuator valve spools 138 and 140. Similar numerals are used to identify the elements that are common, although prime notations are used.

FIG. 3a shows a more complete cross-sectional view of an actuator valve assembly corresponding to the design illustrated in FIG. 3 schematically. The two-stage actuator valve assembly corresponding to the design of FIG. 3 has an inlet port 162 that communicates with passage 132 and an outlet port 164 that communicates with passage 150. The port 162 includes a metering valve land on valve spool 166. Similarly, valve spool 168 includes a metering valve land for port 172. Ports 162 and 172 communicate with passage 150 through the metering valve lands. Outlet port 170 communicates with passage 150. The flow metering lands for valve spool 168 have a large flow area for opening and closing of the engine valve 158. Valve spool 166 has a relatively small flow area. The reduced flow area for valve spool 166 will achieve a smooth valve seating for the engine valve 158 against its valve seat. This will be explained subsequently with reference to FIG. 4.

In the positions shown in FIG. 3a, the valve spools 168 and 166 are seated against a central valve stop 174, which may be a ferrous magnetic material.

As seen in FIG. 3a, the right-hand end of valve spool 166 is situated adjacent an electromagnetic solenoid core, which may be a ferrous material as seen at 176. A small air gap 178 is situated between the right-hand end of the valve spool 166 and the adjacent face of ferrous solenoid core 176, which may be part of an end cap for valve spool housing 184. In the case of the valve spool 168, the left-hand end of the valve spool is separated by an air gap 180 from the adjacent face of a ferrous solenoid core 182. The solenoid core 182 also may be part of an end cap for spool housing 184, as seen at 186.

Valve spools 168 and 166 are positioned in a valve opening in the valve housing 184. When solenoid windings for solenoid actuator 185 are electrically energized, valve spool 166 will shift in a right-hand direction, which will block communication between pressure passage 132 and actuator pressure inlet passage 150. The valve spool 166 is formed of magnetic material, as is the spool valve 168. When the solenoid windings for solenoid actuator 185 are de-energized and solenoid windings for solenoid actuator 187 are energized, the valve spool 166 will shift in a left-hand direction, thereby opening the air gap 178. The valve stop 174 is engaged by valve spool 166 at this time. This opens communication between pressure passage 132 and actuator passage 150.

When windings for solenoid actuator 189 are energized and solenoid windings for solenoid actuator 187 are de-energized, valve spool 168 will shift in a left-hand direction until the air gap 180 is closed and the left-hand of the valve spool 168 abuts the stator core 182. At that time, communication between pressure passage 132 and actuator pressure passage 150 is blocked.

When the windings for solenoid actuator 187 are electrically energized, the air gaps 180 and 178 will open and the inward ends of the valve spools 168 and 166 will abut the valve stop 174.

In FIG. 4, the valve lift for either engine valve 158 or engine valve 158′ is plotted against time. Engine crank position is directly related to time for a given engine speed. Thus, engine crank position is shown in the time plot of FIG. 4 on the abscissa and engine valve lift is shown on the ordinant. The numerals used in FIG. 4 for the solenoid actuators correspond to numerals used in FIG. 3.

At the beginning of the valve actuating cycle, solenoid actuator 144 is energized at point 188 and switching solenoid 128 is energized. Pressure is distributed from passage 134 to passage 132. A pressure fluid flow area then occurs between passage 132 and passage 150. As each valve spool is moved to its open position with flow areas for the valve spools 166 and 168 open, the pressure in the single-stage actuator 154 begins to rise, causing the engine valve 158 to rise as indicated by the opening ramp 190 in FIG. 4. When the valve lift reaches the value 192, seen in FIG. 4, solenoid actuator 144 may be de-energized (it is possible to de-energize solenoid actuator 144 prior to this point, depending on the control strategy) and solenoid actuators 146 and 142 are simultaneously energized thereby interrupting pressurized fluid delivery to the actuator, as the valve lift remains constant as shown at 194. When the engine crank position reaches point 196, solenoid actuators 146 and 142 may be de-energized and solenoid actuator 144 is energized, which again opens the pressurized fluid metering areas for both valve spools thereby closing the engine valve, as shown by the closing ramp 198. Switching valve 122 is shifted to the right to exhaust actuator pressure to the reservoir as solenoid actuator 128 is energized. At point 200 in the valve lift plot of FIG. 4, the solenoid actuator 146 is energized, which again closes the flow metering area of the lands of the valve spool 168 while the flow metering area of the valve lands for valve spool 166 remain open. At this time, current to solenoid 144 will be interrupted or at least reduced. This causes the closing ramp slope to change from the value shown at 198 to a lesser value, as shown at 202. The engine valve then is allowed to gently engage the valve seat with reduced energy. The restricted flow resulting from the reduced flow area for valve spool 166 provides a cushion for the engine valve during valve closure. When solenoid actuator 142 is energized, the engine valve opening and closing cycle is ended as both valve spools are closed to prepare for the next engine valve lift cycle.

The solenoid actuators can be deactivated by reducing current, rather than by interrupting current, if the control strategy functions in that fashion.

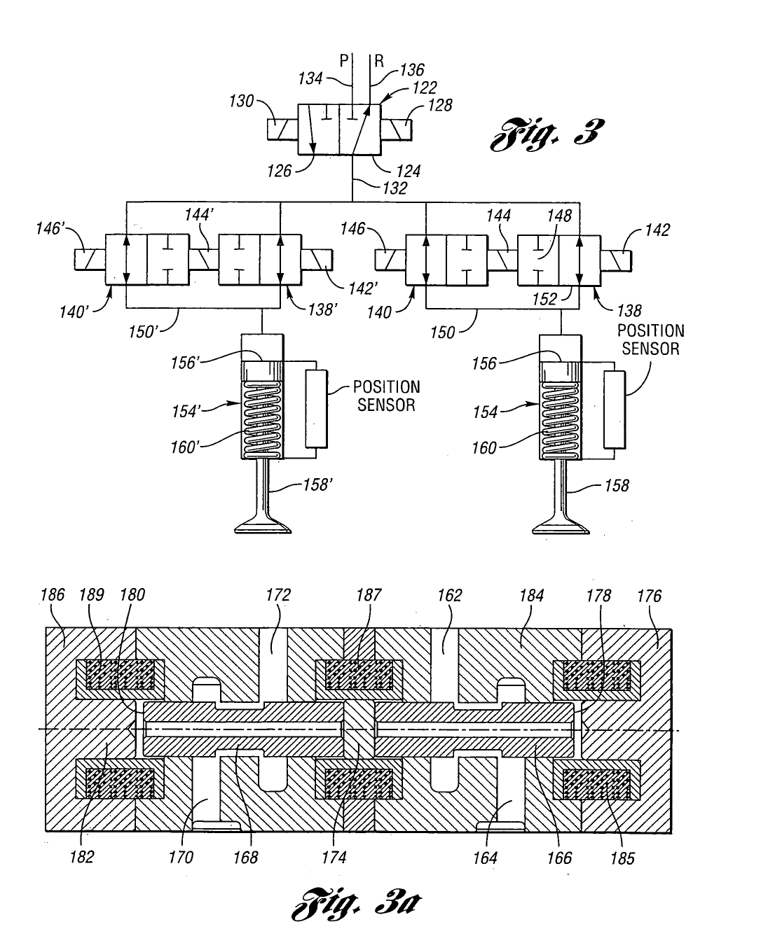

FIG. 5 shows the relationship between pressurized fluid flow and differential pressure across the flow metering lands of the valve spools. The plot shown at 204 is an example of the flow characteristics, but other flow characteristics can be chosen by making appropriate changes in the valve geometry or the control strategy shows the flow characteristics across the large flow area of valve spool 168. The corresponding plot for the flow across the small area valve spool 166 is shown at 206.

The relatively small flow area of valve spool 166 creates the lower slope seating ramp 202 because of the flow characteristics illustrated in FIG. 5. For a given differential pressure across an actuator valve assembly, the flow through the flow metering lands of valve spool 166 is less than the flow through the flow metering lands of valve spool 168. The flow depends upon the Reynolds number, the differential pressure, the metering area and the fluid density. This is indicated by the following well known equation:

$$Q = CA \sqrt{\frac{2 \cdot Δ P}{ρ}}$$

where C is a constant that depends upon Reynolds number, valve spool orifice shape, etc., A is the flow metering area, ΔP is the differential pressure across the flow metering lands and ρ is the fluid density.

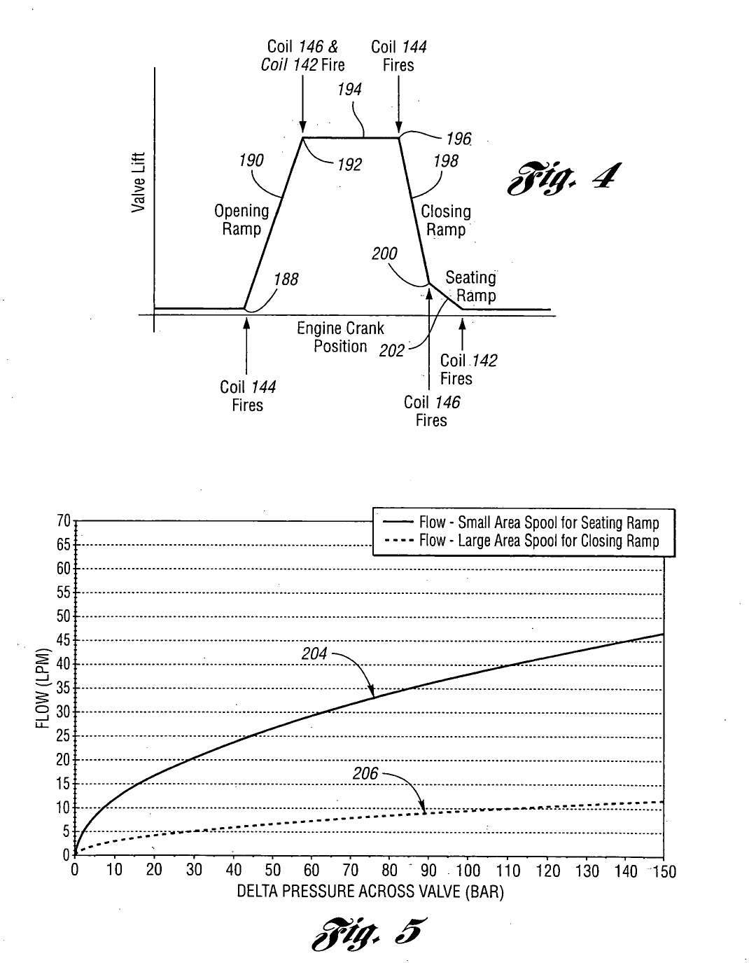

FIG. 6 illustrates the valve porting states in digital form for various engine crankshaft positions during a given engine valve opening and closing cycle. At the crankshaft position corresponding to point 208 in FIG. 6, the actuator pressure passage 132 is open to the pressure passage at 134 in FIG. 3. When the switching valve is opened, it remains open until the crankshaft position corresponding to point 212 is reached.

The actuator valve assembly (138, 140) is opened at point 214 so that the opening ramp 190, seen in FIG. 4, will be developed. The valve porting will remain open until point 216 is reached. At that time, the actuator valve assembly (138, 140) is closed, as shown at 217, so that the valve lift remains unchanged as shown at 194 in FIG. 4. The switching valve is shifted at this time to pressure passage 132. When solenoid coil 144 energized, as shown at 218 in FIG. 6, both valve spools move to their respective open positions, which is shown in FIG. 3a. This creates the closing ramp 198 seen in FIG. 4. The switching valve is shifted at this time to connect passage 132 to the reservoir passage 136. At the crankshaft position corresponding to point 220 in FIG. 6, the larger flow area valve spool 168 is closed by energizing solenoid actuator 146 and de-energizing solenoid actuator 146. Residual magnetism in stop 174 will hold valve spool 186 in the position shown in FIG. 3a. All of the flow then takes place through the smaller flow area actuator valve spool 166 thereby creating the seating ramp 202. At the crankshaft position corresponding to point 222, valve spool 166 is closed as solenoid coil 142 is energized while valve spool 168 remains closed.

FIGS. 7-10 illustrate another embodiment of the invention. Unlike the embodiment of FIGS. 3-6, the embodiment of FIGS. 7-10 includes a single-acting, two-stage actuator rather than a single-acting, single-stage actuator. An actuator that may be used in the embodiment of FIGS. 7-10 is a two-stage actuator described with reference to FIG. 1b, where a large diameter actuator piston is disposed concentrically with respect to a smaller diameter piston. The embodiment of FIGS. 7-10 does not require a switching valve of the kind shown at 122 in FIG. 3. In FIG. 7, a pressure passage communicates with a first two-stage actuator valve spool 236. The single-acting, two-stage actuator is schematically illustrated at 226, but it will not be described particularly since it would function in a manner similar to the function of the two-stage actuator shown in FIG. 1b. The actuator 226 acts on engine valve 228.

A second single-acting, two-stage actuator is shown at 226′ for operating a second engine valve 228′. A two-stage actuator valve spool corresponding to two-stage actuator valve spool 224 is shown at 236′. This valve spool controls the operation of the actuator for the engine valve 228′. Only one of the actuator valve assemblies will be described since they essentially are similar in structure and function. The elements of the two-stage actuator valve assembly for engine valve 228′ have corresponding elements in the actuator valve assembly for engine valve 228, are designated by similar reference characters, although prime notations are added.

A pressure passage 230 communicates with valve spool 236 and an exhaust passage or reservoir passage communicates with valve spool 224, as shown at 232. As in the case of the embodiment of FIG. 3, actuator valve spool 224 has a companion actuator valve spool 236. Each has two positions. The valve spools are shifted from one position to the other by three solenoid actuators 238, 240 and 242. When solenoid actuator 238 is energized, valve spool 246 is shifted to position 244 to establish communication between passages 248 and 232. When solenoid actuator 240 is energized and solenoid actuators 238 and 242 are de-energized, valve spool 224 is shifted to position 246 to block communication between passages 248 and 232, and valve spool 236 is shifted to block communication between passages 230 and 248. When solenoid actuator 242 is energized and solenoid actuator 240 is de-energized, communication is established between passages 248 and 230. Residual magnetism in stop 226 holds valve spool 224 in the position shown in FIG. 7. When solenoid actuator 242 is de-energized and solenoid actuator 240 is energized, communication between passages 248 and 230 is blocked.

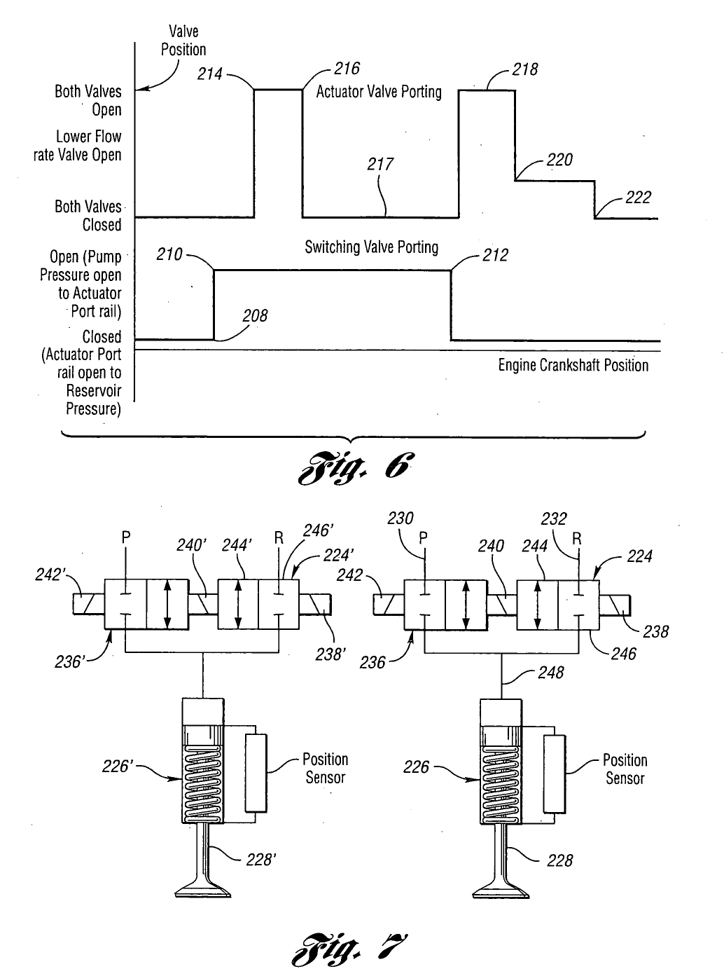

A more complete sectional view of an actuator valve assembly corresponding to the actuator valve spools 224 and 236 is illustrated in FIG. 8. The actuator valve assembly of FIG. 8 includes two valve spools, as shown at 250 and 252. Each valve spool has a flow metering land with a metering land edge, as shown at 254 and at 256, respectively. A low pressure reservoir port is shown at 258 and the pressure flow inlet port from a pump, not shown, is shown at 260. A pressure inlet port for valve spool 252 is shown at 260. A pressure exit port for valve spool 252 is shown at 264.

A valve stop 266, which has magnetic properties, is disposed between adjacent ends of the valve spools 250 and 252. It is surrounded by windings for solenoid actuator 240. As in the case of the actuator valve assembly of FIG. 3a, the design of FIG. 8 has end caps 265 and 268, which define solenoid cores within the solenoid coils 238 and 242, respectively.

When one of the valve spools is shifted by an electromagnetic force created by selective activation of the solenoid actuators, the companion valve spool should not be shifted. It can be stabilized in its current position by reason of a residual magnetism created in the valve stop 266 of FIG. 8, or in the valve stop 174 in the case of the design of FIG. 3a. The same is true when either of the valve spools is moved away from the stop 226 or 174 and engages its end cap 265 or 268, respectively, or its end caps 176 or 186, respectively. The development of this residual magnetism results in a stabilizing force on the valve spools. This can best be understood by referring to FIG. 12, where magnetic field intensity is plotted as a function of magnetic flux density. As the electromagnetic coils are energized, the magnetic flux density will increase, as shown by curve 270. When the windings are de-energized, the magnetic flux density will decrease, as shown by the plot 272. Because of normal hysterisis, which is a well-known phenomenon, the magnetic flux density will not return to its original value when the coil is de-energized. The difference between the magnetic flux density during a magnetic flux intensity build-up and the magnetic flux density during a decrease in the magnetic flux intensity is designated in FIG. 12 as a hysterisis value. When the magnetic field intensity reaches zero, there will be a residual magnetism, as indicated at 274. An electromagnetic force due to residual magnetism maintains the valve spools in their stable condition when their respective actuator solenoid coils are de-energized.

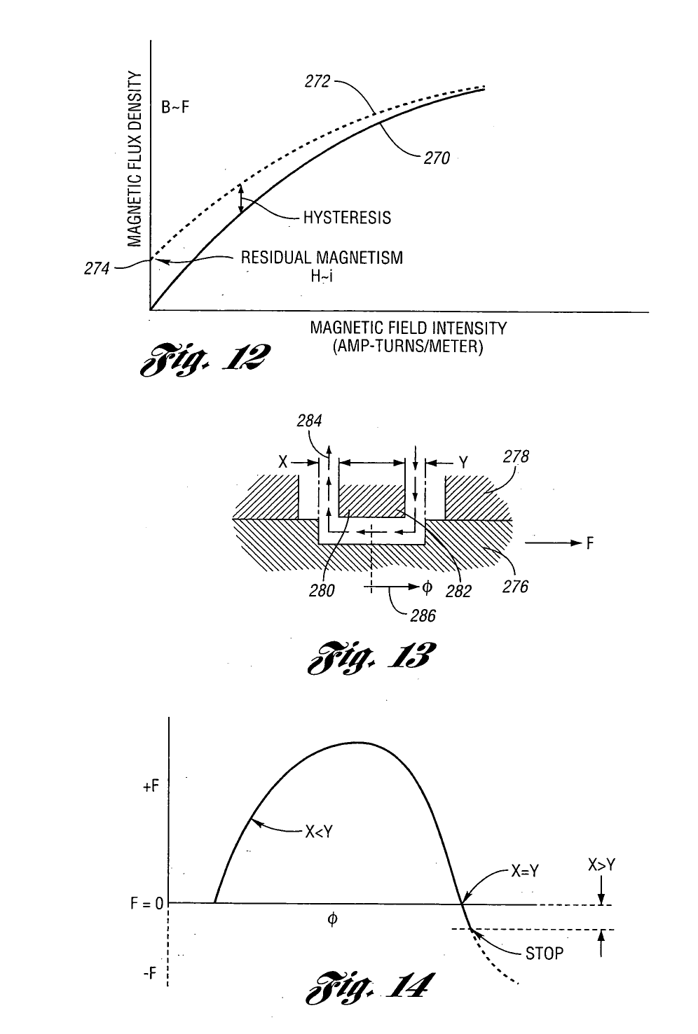

FIG. 13 demonstrates how hydrostatic forces can be developed in a valve spool 276 as it moves relative to a valve opening in valve body 278. A valve land 282 in the valve body and a land on the valve spool create a metering flow exit passage. The land 282 and another valve land on the valve spool 276 create a metering flow inlet passage. As the flow circulates through the valve assembly, the flow changes direction from a parallel flow path to a right angle exit flow path, as indicated at 284. This creates the hydrostatic force “F” on the valve spool, which would tend to oppose displacement φ at 286 of the valve spool relative to the valve body.

If the dimension “X” is greater than the dimension “Y”, as seen in FIG. 13, the fluid flow velocity at the flow inlet passage will be higher than the fluid flow velocity at the flow exit passage. Because of a Bernoulli effect, the static pressure acting on the face of the valve spool land at the flow exit passage is higher than the static pressure on the face of the valve spool land at the flow inlet passage. This creates a force “F” on the valve spool.

FIG. 14 shows a plot that demonstrates the functional relationship between the displacement φ and a force F. The value “X” indicated in FIGS. 13 and 14 represents the size of the flow metering area at the flow exit indicated in FIG. 13. The value “Y” represents the flow area created by the registering valve lands at the flow entrance indicated in FIG. 13. When “X” is equal to “Y”, the force “F” is zero. When “X” is less than “Y”, a positive force is developed. If “X” is greater than “Y”, a negative force is developed, as the valve spool engages the valve stop.

FIG. 9 shows the control strategy for the embodiment of the invention shown in FIGS. 7 and 8. FIG. 9 is a plot of engine crankshaft position versus valve lift. At point 288 in FIG. 9, solenoid actuator 242 is energized. This creates an opening ramp for the valve lift. At the initial phase of the ramp indicated at 290, both the large diameter piston and the small diameter piston of the single-acting, two-stage actuator work together. At point 292, the large diameter piston bottoms against the seat corresponding to seat 98 of FIG. 1b. Thereafter, the engine valve will be lifted at a faster rate, shown at 294, because it is being driven by the smaller diameter piston toward the open position. This open position is indicated at 298.

At point 298 in FIG. 9, solenoid actuator 240 is energized. This closes communication between pressure port 260, shown in FIG. 8, and port 264 leading to the actuator. It also closes communication between the actuator and the port 258 leading to the reservoir. The engine crank position then continues to increase with an unchanging engine valve lift, as shown at 300. At point 302, solenoid actuator 238 is energized and solenoid actuator 240 is de-energized, thereby opening communication between port 262 and port 258 leading to the reservoir. Previously closed port 260 remains closed as valve spool 252 is held stable in its closed position by residual magnetism in stop 266. An engine valve closing ramp then occurs, as shown at 304, as the actuator small diameter piston displaces fluid from an actuator pressure chamber corresponding to pressure chamber 82 in FIG. 1b. When a small diameter piston stop corresponding to stop 78 of FIG. 1b engages the large diameter piston, a break occurs in the closing ramp, as shown at 308, at which time the fluid in the pressure chamber of the actuator is displaced by the large diameter piston. This results in a seating ramp that has a lower slope than the slope of the closing ramp 304.

At point 310, the solenoid actuator 240 again is energized, thereby closing port 264 and port 262. The actuator valve assembly 224 thus is prepared for the next valve lift cycle.

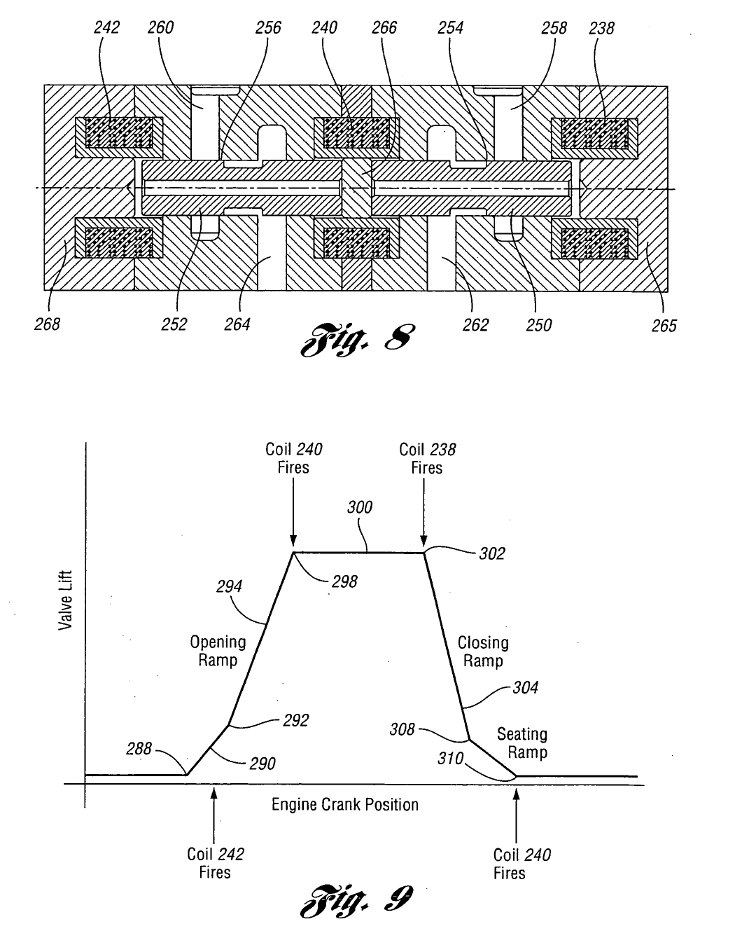

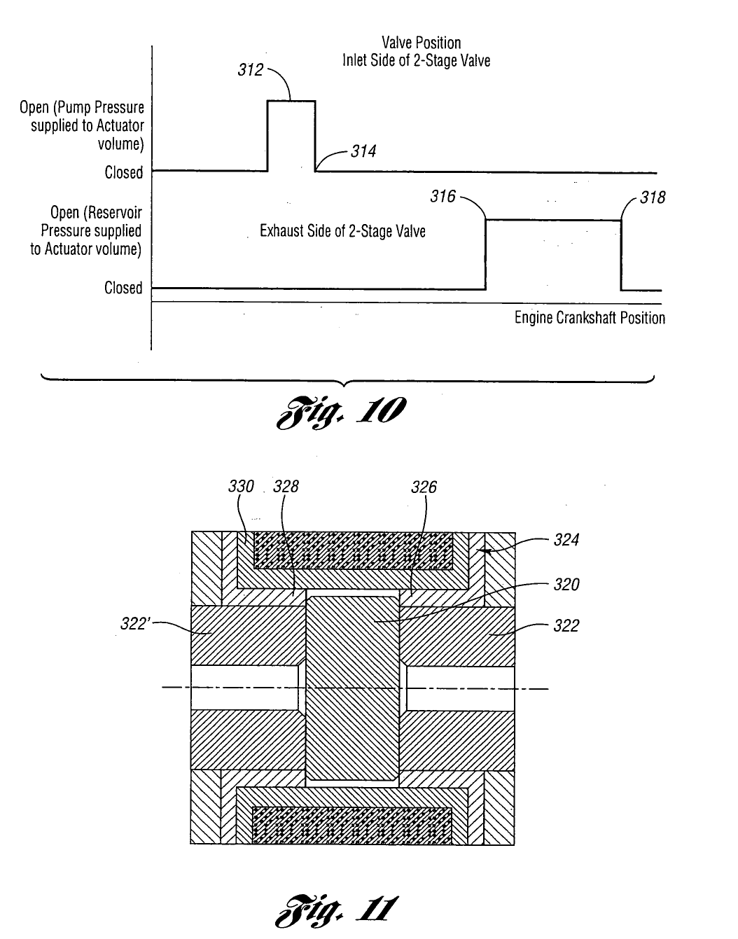

FIG. 10 shows a plot of the pump pressure supplied to the actuator at the pressure inlet side of the actuator valve assembly during the initial engine valve lift. That engine valve position is indicated at 312. When solenoid actuator 240 is energized at point 298 in FIG. 9, the actuator valve assembly closes. This is seen at crank position 314 in FIG. 11. FIG. 10 also shows the actuator valve assembly position when the reservoir communicates with the actuator pressure chamber. At a crank position corresponding to point 316 in FIG. 10, solenoid actuator 238 is energized (fired) and the ramping of the engine valve shown at 304 and 308 takes place. At the crank position corresponding to point 318 in FIG. 10, the solenoid actuator 240 again is energized and the actuator valve assembly is closed.

FIG. 11 shows a modification that may be applied to the two-stage actuator valve assembly shown in FIG. 8 as well as to the two-stage actuator valve assembly shown in FIG. 3a. FIG. 11 shows a valve spool stop 320 situated between the adjacent ends of actuator valve spools 322 and 322′. A metallic bridge 324 surrounds the actuator valve ends. The bridge comprises a first bridge part 326 and a second bridge part 328, which abut the actuator valve stop 320 and secure the valve stop in place. This prevents the valve stop from shifting as the windings of the solenoid actuators are energized and de-energized. Radially outward portions of the bridge parts 326 and 328 engage solenoid winding spool 330, which in turn is fixed to the valve housing.

Although the bridge may comprise two separate parts, as shown in FIG. 11, it could instead be formed integrally with a central groove for receiving the stop 320. The stop could be secured in an integral bridge by means of a press fit.

The bridge 324 and the stop 320 are made of a material that may be magnetized so that the magnetic flux intensity created by the bridge create an increased magnetic force due to residual magnetism after the solenoid windings for spool 330 are de-energized.

Although embodiments of the invention have been disclosed, it will be apparent to a person skilled in the art that modifications may be made without departing from the scope of the invention. All such modifications and equivalents thereof are intended to be covered by the following claims.

What is claimed is:

1. A digital valve assembly for controlling distribution of fluid pressure to a fluid pressure actuator and release of fluid pressure from the fluid pressure actuator, the digital valve assembly comprising:
first and second actuator valve elements, each valve element having a first position whereby fluid pressure distribution between a fluid pressure source and the fluid pressure actuator is established and a second position whereby fluid pressure distribution between the fluid pressure source and the fluid pressure actuator is interrupted;
a first electrical solenoid adjacent one end of the first valve element;
a second electrical solenoid adjacent the other end of the first valve element and one end of the second valve element; and
a third electrical solenoid adjacent the other end of the second valve element;
the first solenoid being adapted to shift the first valve element to one of its positions when it is energized;
the second solenoid being adapted to shift the first valve element to the other of its positions and to shift the second valve element to one of its positions when it is energized;
the third electrical solenoid being adapted to shift the second valve element to the other of its positions when it is energized.

2. The digital valve assembly set forth in claim 1 wherein each of the valve elements comprises a valve spool, the valve spools being in axial alignment;
the second electrical solenoid, when it is energized, having a magnetic flux field that establishes a magnetic force on adjacent ends of the first and second actuator valve elements to effect the shift of each actuator valve element.

3. The digital valve assembly set forth in claim 1 wherein the second electrical solenoid, when it is energized, has a magnetic flux field that simultaneously shifts the first and second valve elements to one of their respective positions.

4. The digital valve assembly set forth in claim 1 wherein each of the valve elements has valve lands that define fluid flow metering areas, the fluid flow metering area of one valve element being larger than the fluid flow metering area of the other valve element;
one metering flow area accommodating flow from the fluid pressure actuator at a first flow rate and the other metering flow area accommodating flow from the fluid pressure actuator at a reduced flow rate as the solenoids are selectively energized and de-energized.

5. The digital valve assembly set forth in claim 4 wherein the one metering flow area accommodates flow from the fluid pressure actuator during a time interval at a beginning of flow of fluid from the fluid pressure actuator in a fluid pressure actuator deactivation event and wherein the other metering flow area accommodates flow from the fluid pressure actuator during a time interval at an end of the deactivation event.

6. The digital valve assembly set forth in claim 5 wherein the one metering flow area is larger than the other metering flow area.

7. A digital valve assembly for controlling distribution of fluid pressure to and from a fluid pressure actuator for a reciprocating valve that is lifted out of engagement with a valve seat and moved into engagement with the valve seat, the digital valve assembly comprising:
first and second actuator valve spools arranged on a common axis, each valve spool being disposed in a valve body, the valve body defining a fluid flow port for each valve spool;
a first electrical solenoid means for shifting the first valve spool away from the second spool when it is energized,
a second electrical solenoid means for shifting both valve spools toward each other; and
a third electrical solenoid means for shifting the second valve spool away from the first valve spool.

8. The digital valve assembly set forth in claim 7 including a valve spool stop disposed between adjacent ends of the first and second valve spools.

9. The digital valve assembly set forth in claim 8 wherein the second electrical solenoid means includes solenoid windings that surround the valve spool stop;
the second solenoid means being adapted to establish, when the solenoid windings are energized, a magnetic flux field that develops a valve spool actuating force on the first and second valve spools to shift the first and second valve spools into engagement with the valve element stop.

10. The digital valve assembly set forth in claim 9 wherein the fluid pressure actuator is drivably connected to the reciprocating valve whereby the reciprocating valve is lifted at a controlled rate from a seated position as the second electrical solenoid means is energized;
the reciprocating valve lift being unchanged for a calibrated interval as the first and third electrical solenoid means are energized;
the reciprocating valve lift decreasing at a controlled rate when the second electrical solenoid means is energized.

11. The digital valve assembly set forth in claim 10 wherein the reciprocating valve lift is reduced at a decreased controlled rate when the first electrical solenoid means is energized whereby the reciprocating valve softly engages the valve seat.

12. The digital valve assembly set forth in claim 11 wherein the third electrical solenoid means is energized when the reciprocating valve element engages the valve seat whereby the digital valve assembly is prepared for a subsequent reciprocating valve control event.

13. The digital valve assembly set forth in claim 7 wherein the valve spools define metering fluid flow areas for controlling fluid flow to and from each of the valve spools;
the metering fluid flow area for the second valve spool being smaller than the metering fluid flow area for the first valve spool.

14. The digital valve assembly set forth in claim 7 wherein distribution of fluid pressure to and from the fluid pressure actuator is controlled by both the actuator valve spools and a switching valve;
the switching valve being disposed in a fluid flow circuit between the actuator valve spools and a pressure source and between the actuator valve spools and a low pressure reservoir whereby pressurized fluid is supplied to the digital valve assembly when the switching valve assumes one position and pressurized fluid is discharged to the low pressure reservoir when it assumes a second position.

15. The digital valve assembly set forth in claim 14 wherein the switching valve comprises a movable valve spool with two operating positions and selectively activated electrical solenoid means for shifting the switching valve from one of its two operating positions to the other.

16. A digital valve assembly set forth in claim 9 wherein the fluid pressure actuator is drivably connected to the reciprocating valve whereby the reciprocating valve is lifted at a controlled rate from a seated position as the first electrical solenoid means is energized;
the reciprocating valve lift being unchanged for a calibrated interval as the second electrical solenoid means is energized;
the reciprocating valve lift decreasing at a controlled rate when the third electrical solenoid means is energized as the reciprocating valve is seated, the second electrical solenoid means being energized when the reciprocating valve is seated whereby the digital valve assembly is prepared for a subsequent reciprocating valve control event.

17. A digital valve assembly for controlling distribution of fluid pressure to a fluid pressure actuator and release of fluid pressure from the fluid pressure actuator, the digital valve assembly comprising:
first and second actuator valve elements, each valve element having a first position whereby fluid pressure distribution between a fluid pressure source and the fluid pressure actuator is established and a second position whereby fluid pressure distribution between the fluid pressure source and the fluid pressure actuator is interrupted;
a first electrical solenoid for activating the first valve element to a first position;
a second electrical solenoid for activating the first valve element to its second position and for activating the second valve element to its first position; and
a third electrical solenoid for activating the second valve element to its second position.

18. The digital valve assembly set forth in claim 17 wherein each of the valve elements comprises a valve spool, the valve spools being in axial alignment;
the second electrical solenoid, when it is energized, having a magnetic flux field that establishes a magnetic force on the first and second actuator valve elements to effect the shift of each actuator valve element.

19. The digital valve assembly set forth in claim 17 wherein the second electrical solenoid, when it is energized, has a magnetic flux field that establishes a magnetic force to simultaneously shift the first and second valve elements to one of their respective positions.

20. The digital valve assembly set forth in claim 17 wherein each of the valve elements has valve lands that define fluid flow metering areas, the fluid flow metering area of one valve element being larger than the fluid flow metering area of the other valve element;
one metering flow area accommodating flow from the fluid pressure actuator at a first flow rate and the other metering flow area accommodating flow from the fluid pressure actuator at a reduced flow rate as the solenoids are selectively energized and de-energized.

21. The digital valve assembly set forth in claim 20 wherein the one metering flow area accommodates flow from the fluid pressure actuator during a time interval at a beginning of flow of fluid from the fluid pressure actuator in a fluid pressure actuator deactivation event and wherein the other metering flow area accommodates flow from the fluid pressure actuator during a time interval at an end of the deactivation event.

22. A digital valve assembly for controlling distribution of fluid pressure to and from a fluid pressure activated element, the digital valve assembly comprising:
first and second actuator valve spools, each valve spool being disposed in a valve body, the valve body defining a fluid flow port for each valve spool;
a first electrical solenoid means for shifting the first valve spool away from the second spool when it is energized,
a second electrical solenoid means for shifting both valve spools toward each other; and
a third electrical solenoid means for shifting the second valve spool away from the first valve spool.

23. The digital valve assembly set forth in claim 22 including a valve spool stop disposed between adjacent ends of the first and second valve spools.

24. The digital valve assembly set forth in claim 23 wherein the second electrical solenoid means includes solenoid windings that surround the valve spool stop;
the second solenoid means being adapted to establish, when the solenoid windings are energized, a magnetic flux field that develops a valve spool actuating force on the first and second valve spools to shift the first and second valve spools into engagement with the valve element stop.

25. The digital valve assembly set forth in claim 22 wherein distribution of fluid pressure to and from the fluid pressure activated element is controlled by both the actuator valve spools and a switching valve;
the switching valve being disposed in a fluid flow circuit between the actuator valve spools and a pressure source and between the actuator valve spools and a low pressure reservoir whereby pressurized fluid is supplied to the digital valve assembly when the switching valve assumes one position and pressurized fluid is discharged to the low pressure reservoir when it assumes a second position.

26. The digital valve assembly set forth in claim 25 wherein the switching valve comprises a movable valve spool with two operating positions and selectively activated electrical solenoid means for shifting the switching valve from one of its two operating positions to the other.
